(19) United States
(12) Patent Application Publication
(10) Pub. No.: US 2018/0215129 A1
(43) Pub. Date: Aug. 2, 2018

(54) FUNCTIONALLY GRADED MATERIAL, COIL, INSULATION SPACER, INSULATION DEVICE, AND METHOD FOR MANUFACTURING FUNCTIONALLY GRADED MATERIAL

(71) Applicant: HITACHI, LTD., Tokyo (JP)

(72) Inventors: Yasuhiko TADA, Tokyo (JP); Takahito MURAKI, Tokyo (JP); Yuri KAJIHARA, Tokyo (JP); Takeshi KONDO, Tokyo (JP); Tadashi ARAI, Tokyo (JP)

(73) Assignee: HITACHI, LTD., Tokyo (JP)

(21) Appl. No.: 15/748,533

(22) PCT Filed: Jul. 31, 2015
(86) PCT No.: PCT/JP2015/071738

§ 371 Date: Jan. 29, 2018

(51) Int. Cl. B32B 27/08; H01B 3/40; H02K 3/30

(52) U.S. Cl. CPC B32B 27/08; H02K 3/30; H01B 3/40

(57) ABSTRACT

A functionally graded material according to the present invention adopts, for example, the following configuration. A functionally graded material is constituted by laminating a plurality of resin compositions. Among the plurality of resin compositions, a first resin composition has a different property from a second resin composition adjacent to the first resin composition. An interface between the first resin composition and the second resin composition is joined by a dynamic covalent bond.

### TECHNICAL FIELD

The present invention relates to a functionally graded material.

### BACKGROUND ART

An electrical device coil of a rotating machine such as a motor, a static machine such as a transformer, or the like, a power device used for a power electronics device, a gas insulation device, or the like has been miniaturized from a viewpoint of energy saving and economy, and requires high output and large capacity. An insulation material of such a device requires high withstand voltage characteristics, and attention is paid particularly to a technique for realizing electric field relaxation of an electric field concentration portion. For example, in a gas insulation device, it is an object to relax an electric field at a triple point which is an intersection of an insulation spacer, a conductor, and an insulation spacer for insulating and supporting the conductor, disposed in a container. Therefore, in order to realize electric field relaxation, the following method for changing a dielectric constant inside an insulation spacer has been proposed.

PTL 1 discloses an insulation spacer in which a dielectric constant is graded by preparing a string-like extruded product while a thermosetting resin, an inorganic filling material, and an inorganic filling material having a lower dielectric constant are in an uncured molten state, filling the extrusion product spirally in a spacer lower die, and curing the extrusion product.

PTL 2 discloses a method for winding a resin impregnated tape around a body portion, and then injecting a resin having a dielectric constant lower than that of a material of the resin impregnated tape for integral molding.

PTL 3 discloses a method for sequentially laminating a plurality of layers having different dielectric constants.

PTL 4 discloses a method for controlling a discharge volume from a plurality of reservoirs of different compositions, and injecting and filling the discharged solution sequentially into a casting die for hot-molding.

### CITATION LIST

### Patent Literature

PTL 1: JP 11-126527 A

PTL 2: JP 11-262143 A

PTL 3: JP 2005-327580 A

PTL 4: JP 2010-176969 A

### SUMMARY OF INVENTION

### Technical Problem

A material in which a property such as a dielectric constant is graded inside the material is referred to as a functionally graded material. A related art material used in the functionally graded material is generally a thermosetting resin, and a process for manufacturing the functionally graded material by the conventional method described above is complicated. In addition, such a manufacturing process uses centrifugation or the like, and a graded direction of characteristics depends on a gravity direction, and a molding method is limited. Furthermore, it is difficult to deal with a complex shape.

### Solution to Problem

A functionally graded material is constituted by laminating a plurality of resin compositions. Among the plurality of resin compositions, a first resin composition has a different property from a second resin composition adjacent to the first resin composition. An interface between the first resin composition and the second resin composition is joined by a dynamic covalent bond.

### Advantageous Effects of Invention

By adopting the present invention, it is possible to provide a functionally graded material realized with a simple configuration. As a result, in a product using a functionally graded material, a withstand voltage can be improved.

### BRIEF DESCRIPTION OF DRAWINGS

FIG. 1 is a schematic cross-sectional view of a functionally graded material.

FIG. 2 is a schematic cross-sectional view of an insulation spacer for a single layer.

FIG. 3 is an overhead view of an insulation spacer for three phases.

FIG. 4 is an upper side view of a motor coil.

FIG. 5 is a schematic cross-sectional view of a motor using a motor coil.

### DESCRIPTION OF EMBODIMENTS

Hereinafter, an embodiment of a functionally graded material will be described in detail with reference to the drawings appropriately. This functionally graded material is characterized in that a laminate having a dielectric constant change is manufactured by arranging resin compositions having different dielectric constants such that a difference in dielectric constant is positive or negative and bonding the two resin compositions to each other by a dynamic covalent bonding incorporated in the resin compositions. Note that the dielectric constant may change continuously or stepwise.

In the functionally graded material, a part of the material has a property (characteristic) different from another part, that is, a property changes continuously or stepwise in one material. The functionally graded material is constituted by laminating a plurality of resin compositions. In a case where it is desired to improve a withstand voltage, the changing property is preferably a dielectric constant. The dielectric constant may change in a thickness direction or in a direction perpendicular to the thickness direction. A difference in dielectric constant between adjacent resin compositions is positive or negative all the time.

For example, a resin composition is formed such that a difference Δε in dielectric constant between adjacent resin compositions represented by formula 1 is positive or negative all the time.

Δε=εₙ−εₙ₊₁ (εₙ: dielectric constant of resin composition with nₜₕ laminating order, εₙ₊₁: dielectric constant of resin composition with (n+1)ₜₕ laminating order) [Formula 1]

A dielectric constant change in the present embodiment is controlled by a filling material, and examples of the filling material include silica, alumina, titanium oxide, barium titanate, and strontium titanate.

Furthermore, for bonding adjacent resin compositions to each other, a dynamic covalent bond capable of reversible dissociation and addition by external stimulation incorporated in the resin compositions is used. By use of a material of an adhesive, a material derived from the adhesive is mixed with a resin composition, and an adhesive layer is formed between adjacent resin compositions. At this time, the adhesive layer has a lower dielectric constant than the resin compositions, and therefore a withstand voltage is partially lowered in the adhesive layer. By use of a dynamic covalent bond for bonding adjacent resin compositions to each other, it is possible to avoid mixing of a material derived from an adhesive into the resin compositions, and to improve a withstand voltage of a functionally graded material.

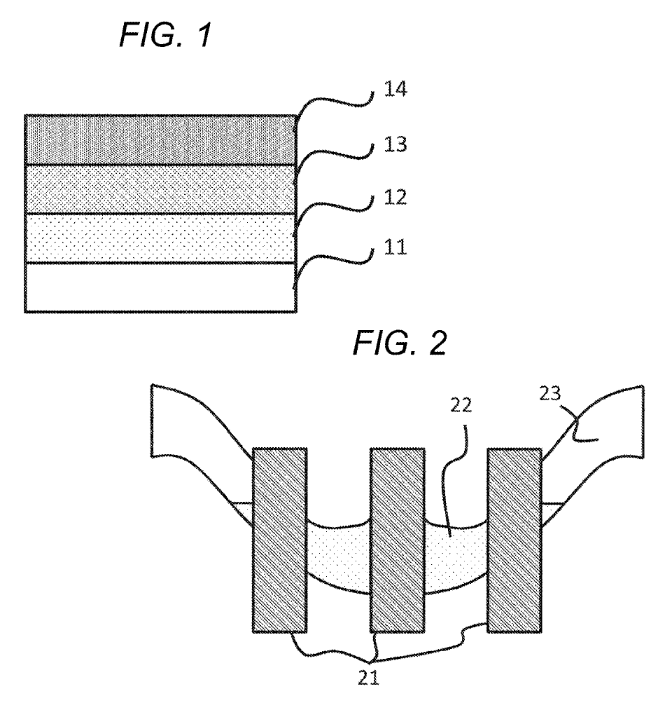

FIG. 1 is a schematic cross-sectional view of a functionally graded material. A dielectric constant ε changes to dielectric constants ε1 to ε4 (ε1<ε2<ε3<ε4). Here, each of an interface between a resin composition 11 having the dielectric constant ε1 and a resin composition 12 having the dielectric constant ε2, an interface between the resin composition 12 having the dielectric constant ε2 and a resin composition 13 having the dielectric constant ε3, and an interface between the resin composition 13 having the dielectric constant ε3 and a resin composition 14 having the dielectric constant ε4 is joined by a dynamic covalent bond.

### <Thermosetting Resin>

A thermosetting resin in the present embodiment has a proper curing temperature range depending on a curing agent and a catalyst, but can be obtained by heating a mixture of a monomer as a main chain, a curing agent, and a catalyst at room temperature to 200° C. Here, desirably, a bond formed by a reaction between the monomer and the curing agent can exhibit a dynamic covalent bond capable of reversible dissociation and addition by external stimulation, and the catalyst functions for exhibition of the dynamic covalent bond.

The dynamic covalent bond in the present embodiment is a covalent bond but a chemical bond which can be recombined. Examples thereof include a bond using a transesterification reaction, a transamidation reaction, a radical reaction utilizing an alkoxyamine bond, a boric acid bond formation-cleavage equilibrium of a borate, or a Diels-Alder reaction.

Specific examples of the monomer and the curing agent include a monomer to form an ester bond and a hydroxy group at the time of curing and a structure having an ester bond and a hydroxy group as a monomer skeleton. As the monomer, an epoxy compound having a polyfunctional epoxy group is desirable. As the curing agent, a carboxylic acid anhydride or a polyvalent carboxylic acid is desirable.

Preferable examples of the epoxy compound include a bisphenol A type resin, a novolak type resin, an alicyclic resin, and a glycidyl amine resin. Examples thereof include bisphenol A diglycidyl ether phenol, bisphenol F diglycidyl ether, bisphenol S diglycidyl ether, resorcinol diglycidyl ether, hexahydrobisphenol A diglycidyl ether, polypropylene glycol diglycidyl ether, neopentyl glycol diglycidyl ether, phthalic acid diglycidyl ester, dimer acid diglycidyl ester, triglycidyl isocyanurate, tetraglycidyl diaminodiphenyl methane, tetraglycidyl meta xylene diamine, cresol novolac polyglycidyl ether, tetrabromobisphenol A diglycidyl ether, and bisphenol hexafluoroacetone diglycidyl ether, but are not limited thereto.

Examples of the carboxylic acid anhydride or polyvalent carboxylic acid as a curing agent include phthalic anhydride, tetrahydrophthalic anhydride, hexahydrophthalic anhydride, methyltetrahydrophthalic anhydride, 3-dodecenylsuccinic anhydride, octenylsuccinic acid anhydride, methyl hexahydrophthalic anhydride, methylnadic anhydride, dodecylsuccinic anhydride, chlorendic anhydride, pyromellitic anhydride, benzophenonetetracarboxylic acid anhydride, ethylene glycol bis(anhydrotrimate), methylcyclohexene tetracarboxylic acid anhydride, trimellitic anhydride, polyazelaic acid anhydride, ethylene glycol bisanhydrotrimellitate, 1,2,3,4-butanetetracarboxylic acid, 4-cyclohexene-1,2-dicarboxylic acid, and polyfatty acid, but are not limited thereto.

As an example of a catalyst for exhibiting a dynamic covalent bond, a catalyst uniformly dispersed in a mixture to promote a transesterification reaction is preferable. Examples thereof include an organic catalyst such as N,N-dimethyl-4-aminopyridine, diazabicycloundecene, diazabicyclononene, triazabicyclodecene, 2-phenylimidazole, 2-phenyl-4-methylimidazole, 1-benzyl-2-phenyl imidazole, or 1-cyanoethyl-2-phenyl imidazole, zinc(II) acetate, zinc(II) acetylacetonate, acetylacetone iron(III), acetylacetone cobalt(II) acetylacetone cobalt(III), aluminum isopropoxide, and titanium isopropoxide, but are not limited thereto.

Examples of another thermosetting resin having a dynamic covalent bond include a diarylbenzofuranone skeleton, a resin crosslinked with dilyclopentadiene, and a resin formed by a polyfunctional furan and phthalimide, but are not limited thereto, and can be selected according to intended use and use environment.

### <Filling Material>

Examples of a filling material in the present embodiment include an inorganic oxide such as silica, alumina, barium titanate, strontium titanate, calcium titanate, or titanium oxide. The particle size thereof, the filling amount thereof, and the like may be appropriately changed according to conditions of a manufacturing process for manufacturing a functionally graded material. Furthermore, in order to change a dielectric constant, the dielectric constant can be changed by changing the size, the kind, the content ratio, or the blending ratio of a filling material.

### <Method for Manufacturing Functionally Graded Material>

The functionally graded material of the present embodiment is manufactured, for example, by the following method. A thermosetting resin mixed with a filling material is thermally cured in any shape to prepare a resin composition. By repeating the above step while the size, the kind, the content ratio, or the blending ratio of the filling material is changed, a plurality of resin compositions having different dielectric constants are prepared. The resin compositions having different dielectric constants are laminated, and are heated and pressurized to bond the laminated resin compositions to each other via a dynamic covalent bond. At this time, in order to avoid formation of a void between the laminated resin compositions, it is desirable to pressurize the laminate in a vacuum or to devise a lamination step such that air does not remain in the laminate. In addition, the filling material is adjusted such that a difference in dielectric constant between layers is positive or negative all the time in a thickness direction or in a direction perpendicular to the thickness direction.

### EXAMPLES

Next, the present embodiment will be described more specifically with reference to Examples.

### Example 1

A jER828 epoxy resin (Mitsubishi Chemical Corporation), 1.0 mol equivalent of acid anhydride (HN2200, Hitachi Chemical Co., Ltd.), 1.0 mol equivalent of zinc(II) acetylacetonate, and a filling material were added, and were stirred and mixed in air. Thereafter, the mixture was poured into a plate-shaped die having a thickness of 0.5 mm, and was heated at 120° C. for 12 hours to cure the mixture. Here, in order to manufacture a functionally graded material having a dielectric constant ε changing from 4 to 8, filling materials of different compositions were used for values of ε (4, 6, and 8). Specifically, in a case of ε=4, 45 vol % of silica having an average particle diameter of 4 μm was blended as a filling material. In a case of ε=6, 40 vol % of alumina having an average particle diameter of 8 μm was blended in a filling material. In a case of ε=8, 40 vol % of a mixture obtained by blending alumina having an average particle diameter of 8 μm and barium titanate having an average particle diameter of 2 μm at a ratio of 75:25 (wt:wt) was blended in a filling material.

The cured resin compositions were laminated in order of the value of ε, and were pressurized in order to prevent formation of a void between layers. Thereafter, heating was performed at 150° C. for 12 hours, and the resin compositions were brought into close contact with each other to obtain a laminate having a dielectric constant graded. The dielectric constant of the obtained laminate is indicated in Table 1.

TABLE 1

| | Dielectric | |
|---|---|---|
| Laminate | constant change | Graded direction |
| Example 1 | 8, 6, 4 | ◯: Arbitrary |
| Example 2 | 8, 7, 6, 5, 4 | ◯: Arbitrary |
| Comparative | 8, 4, 6, 4, 4 | ◯: Arbitrary |
| Example 1 | | |
| Comparative | 8 to 4 | X: Gravity direction |
| Example 2 | | |

### Example 2

A jER828 epoxy resin (Mitsubishi Chemical Corporation), 1.0 mol equivalent of acid anhydride (HN2200, Hitachi Chemical Co., Ltd.), 1.0 mol equivalent of zinc(II) acetylacetonate, and a filling material were added, and were stirred and mixed in air. Thereafter, the mixture was poured into a plate-shaped die having a thickness of 0.5 mm, and was heated at 120° C. for 12 hours to cure the mixture. Here, in order to manufacture a functionally graded material having a dielectric constant ε changing from 4 to 8, filling materials of different compositions were used for values of ε (4, 5, 6, 7, and 8). Specifically, in a case of ε=4, 45 vol % of silica having an average particle diameter of 4 μm was blended as a filling material. In a case of ε=5, 40 vol % of a mixture obtained by blending silica having an average particle diameter of 4 μm and alumina having an average particle diameter of 8 μm at a ratio of 85:15 (wt:wt) was blended in a filling material. In a case of ε=6, 40 vol % of alumina having an average particle diameter of 8 μm was blended in a filling material. In a case of ε=7, 40 vol % of a mixture obtained by blending alumina having an average particle diameter of 8 μm and strontium titanate having an average particle diameter of 1 μm at a ratio of 90:10 (wt:wt) was blended in a filling material. In a case of ε=8, 40 vol % of a mixture obtained by blending alumina having an average particle diameter of 8 μm and strontium titanate having an average particle diameter of 1 μm at a ratio of 77:23 (wt:wt) was blended in a filling material.

The cured resin compositions were laminated in order of the value of ε, and were pressurized in order to prevent formation of a void between layers. Thereafter, heating was performed at 150° C. for 12 hours, and the resin compositions were brought into close contact with each other to obtain a laminate having a dielectric constant graded. The dielectric constant of the obtained laminate is indicated in Table 1.

### Comparative Example 1

A jER828 epoxy resin (Mitsubishi Chemical Corporation), 1.0 mol equivalent of acid anhydride (HN2200, Hitachi Chemical Co., Ltd.), 1.0 mol equivalent of 1-cyanoethyl 2-ethyl-4-methyl imidazole, and a filling material were added, and were stirred and mixed in air. Thereafter, the mixture was poured into a plate-shaped die having a thickness of 0.5 mm, and was heated at 120° C. for 12 hours to cure the mixture. Here, in order to manufacture a functionally graded material having a dielectric constant ε changing from 4 to 8, filling materials of different compositions were used for values of ε (4, 6, and 8). Specifically, in a case of ε=4, 45 vol % of silica having an average particle diameter of 4 μm was blended as a filling material. In a case of ε=6, 40 vol % of alumina having an average particle diameter of 8 μm was blended in a filling material. In a case of ε=8, 40 vol % of a mixture obtained by blending alumina having an average particle diameter of 8 μm and barium titanate having an average particle diameter of 2 μm at a ratio of 75:25 (wt:wt) was blended in a filling material.

The cured resin compositions were laminated sequentially such that the values of ε were [8, 4, 6, 4, 4], an adhesive was inserted between layers, and pressurization and bonding were performed to obtain a laminate. The dielectric constant of the obtained laminate is indicated in Table 1.

### Comparative Example 2

A jER828 epoxy resin (Mitsubishi Chemical Corporation), 1.0 mol equivalent of acid anhydride (HN2200, Hitachi Chemical Co., Ltd.), 1.0 mol equivalent of 1-cyanoethyl 2-ethyl-4-methyl imidazole, and a filling material were added, and were stirred and mixed in air. Thereafter, the mixture was poured into a plate-shaped die having a thickness of 1.5 mm in order of grading a dielectric constant, and was heated at 120° C. for 12 hours to cure the mixture to obtain a laminate. Here, in order to manufacture a functionally graded material having a dielectric constant ε changing from 4 to 8, filling materials of different compositions were used for values of ε (4, 6, and 8). Specifically, in a case of ε=4, 45 vol % of silica having an average particle diameter of 4 μm was blended as a filling material. In a case of ε=6, 40 vol % of alumina having an average particle diameter of 8 μm was blended in a filling material. In a case of ε=8, 40 vol % of a mixture obtained by blending alumina having an average particle diameter of 8 μm and barium titanate having an average particle diameter of 2 μm at a ratio of 75:25 (wt:wt) was blended in a filling material.

### Summary of Examples 1 and 2 and Comparative Examples 1 and 2

In Example 1, a functionally graded material in which a dielectric constant chanced stepwise by two steps was prepared. In Example 2, a functionally graded material in which a dielectric constant changed stepwise by one step was prepared. It is also possible to consider that the change in dielectric constant by one step in Example 2 is a continuous change in dielectric constant. In Examples 1 and 2, it is possible to provide a functionally graded material in which a dielectric constant changes stepwise or continuously.

In Comparative Example 1, the dielectric constant decreased from 8 to 4, and then increased from 4 to 6, followed by 4 and 4. Table 1 indicates that the second dielectric constant from the left and the fourth dielectric constant from the left unintentionally decrease because an interface between adjacent resin compositions is joined with an adhesive, and therefore a material derived from an adhesive is mixed in the resin compositions in a portion of an adhesive layer.

In Comparative Example 2, a gradient of a dielectric constant was generated using gravity. In the method of Comparative Example 2, it is difficult to arbitrarily set a graded direction.

### Example 3

### <Insulation Spacer>

FIG. 2 illustrates a schematic cross-sectional view of an insulation spacer for a single phase, manufactured using the functionally graded material of the present embodiment. An insulation spacer was manufactured such that the insulation spacer had through holes for three through conductors 21 to penetrate the insulation spacer at a center of thereof and an insulator 23 was disposed at a position higher than a contact portion between the through conductors 21 and an insulator 22. The insulators 22 and 23 were manufactured by manufacturing dies therefor, injecting a mixture of thermosetting resins each containing a filling material in accordance with the resin composition manufacturing method described in Examples 1 and 2, and thermally curing the mixture. Furthermore, an interface between the manufactured insulators 22 and 23 was joined, and was bonded by pressurization and heating to manufacture a two-layer conical insulation spacer having a dielectric constant graded. As a result of measuring withstand voltage characteristics of the present insulation spacer, a withstand voltage was improved by 21% as compared with a case where only silica was mixed in a filling material.

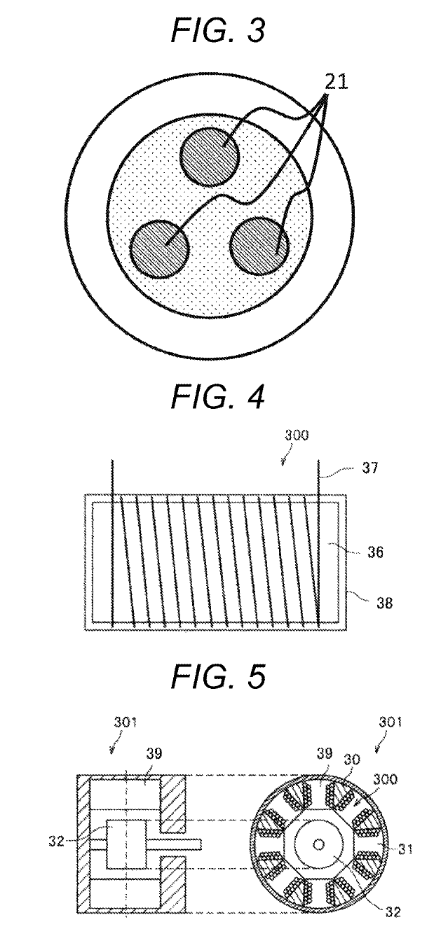

FIG. 3 illustrates a bird's eye view of an insulation spacer for three phases, manufactured using the functionally graded material of the present embodiment. The insulation spacer has three through holes for a through conductor 1 to penetrate the insulation spacer. Therefore, it is difficult to grade a dielectric constant by a method using centrifugation. However, a dielectric constant can be graded by using the functionally graded material of the present embodiment.

In a gas insulation device, it is an object to relax an electric field at a triple point which is an intersection of an insulation spacer, a conductor, and an insulation spacer for insulating and supporting the conductor, disposed in a container. Therefore, by using a gas insulation device including the insulation spacer according to the present embodiment, it is possible to solve electric field relaxation at a triple point.

### Example 4

### <Insulation Material for Motor Coil>

The functionally graded material of the present embodiment can be applied to an insulation portion of a motor coil. A coil for an electric device such as a motor is becoming controlled mainly by an inverter. However, it is necessary to cope with a highly steep surge caused by speedup of pulse control. Therefore, by disposing the functionally graded material of the present embodiment in an electric field concentrated portion of an insulation layer, the electric field is relaxed and insulation reliability is improved.

FIGS. 4 and 5 are views of a motor to which the functionally graded material of the present embodiment is applied. FIG. 4 is a top side view of a motor coil 300, and FIG. 5 is a schematic cross-sectional view of a motor 301 using the motor coil 300. The left side of FIG. 5 is a cross-sectional view in a direction parallel to an axial direction of a rotor magnetic core 32. The right side of FIG. 5 is a cross-sectional view in a direction perpendicular to the axial direction of the rotor magnetic core 32.

The motor coil 300 includes a magnetic core 36, a coated copper wire 37 wound around the magnetic core 36, and a motor coil protection material 38.

The magnetic core 36 consists of, for example, a metal such as iron. Furthermore, an enameled wire having a diameter of 1 mm is used as the coated copper wire 37.

The coil 300 is used for the motor 301 illustrated in FIG. 5. The motor 301 consists of a cylindrical stator magnetic core 30 fixed to an inner edge portion of the motor 301, a rotor magnetic core 32 coaxially rotating inside the stator magnetic core 30, a stator coil 39, and eight coils 300 each obtained by winding a coated copper wire around a slot 31 of the stator magnetic core 30. A coil was manufactured by winding an enameled wire having a diameter of 1 mm around a winding core. A laminate obtained by grading a dielectric constant, obtained by a similar process to Example 1 is disposed in a part of the coated copper wire 37.

### REFERENCE SIGNS LIST

11 Resin composition having dielectric constant ε1
12 Resin composition having dielectric constant ε2
13 Resin composition having dielectric constant ε3
14 Resin composition having dielectric constant ε4
21 Through conductor
22 Insulator
23 Insulator
300 Coil
301 Motor
30 Stator magnetic core
31 Slot
32 Rotor magnetic core
36 Magnetic core
37 Coated copper wire
38 Motor coil protection material
39 Stator coil

1. A functionally graded material constituted by laminating a plurality of resin compositions, wherein
among the plurality of resin compositions, a first resin composition has a different property from a second resin composition adjacent to the first resin composition,
an interface between the first resin composition and the second resin composition is joined by a dynamic covalent bond, and
the functionally graded material comprises a catalyst for exhibiting a dynamic covalent bond.

2. The functionally graded material according to claim 1, wherein
the property is a dielectric constant.

3. The functionally graded material according to claim 1, wherein
a difference Δε in dielectric constant between adjacent resin compositions represented by formula 1 is positive or negative all the time.
Δε=εn−εn+1 (εn: dielectric constant of resin composition with nth laminating order, εn+1: dielectric constant of resin composition with (n+1)th laminating order) [Formula 1]

4. The functionally graded material according to claim 1, wherein
each of the first resin composition and the second resin composition contains an inorganic filling material.

5. The functionally graded material according to claim 4, wherein
the filling material contains at least one of silica, alumina, barium titanate, strontium titanate, calcium titanate, and titanium oxide.

6. The functionally graded material according to claim 5, wherein
the first resin composition is different from the second resin composition in size, kind, content ratio, or blending ratio of the filling material contained therein.

7. The functionally graded material according to claim 1, wherein
the dynamic covalent bond is a dynamic covalent bond capable of reversible dissociation and addition by external stimulation.

8. The functionally graded material according to claim 1, wherein
the resin composition is a thermosetting resin capable of exhibiting a dynamic covalent bond capable of reversible dissociation and addition by external stimulation.

9. A coil insulated by the functionally graded material according to claim 1.

10. An insulation spacer comprising the functionally graded material according to claim 1.

11. An insulation device comprising the insulation spacer according to claim 10.

12. A method for manufacturing a functionally graded material, comprising:
laminating a first resin composition and a second resin composition having a different property from the first resin composition; and
heating the first resin composition, the second resin composition, and a catalyst for exhibiting a dynamic covalent bond to bond the first resin composition to the second resin composition via the dynamic covalent bond.

13. The method for manufacturing a functionally graded material according to claim 12, wherein
the property is a dielectric constant.

14. The method for manufacturing a functionally graded material according to claim 12, wherein
the resin composition contains an inorganic filling material.

15. The method for manufacturing a functionally graded material according to claim 14, wherein
the filling material contains at least one of silica, alumina, barium titanate, strontium titanate, calcium titanate, and titanium oxide.

16. The method for manufacturing a functionally graded material according to claim 15, wherein
the first resin composition is different from the second resin composition in size, kind, content ratio, or blending ratio of the filling material contained therein.

17. The method for manufacturing a functionally graded material according to claim 12, wherein
the dynamic covalent bond is a dynamic covalent bond capable of reversible dissociation and addition by external stimulation.

18. The method for manufacturing a functionally graded material according to claim 12, wherein

19. The functionally graded material according to claim 1, wherein
the catalyst for exhibiting a dynamic covalent bond accelerates a transesterification reaction.

20. The functionally graded material according to claim 1, wherein
the catalyst for exhibiting a dynamic covalent bond is any one of an organic catalyst such as N,N-dimethyl-4-aminopyridine, diazabicycloundecene, diazabicyclononene, triazabicyclodecene, 2-phenylimidazole, 2-phenyl-4-methylimidazole, 1-benzyl-2-phenyl imidazole, or 1-cyanoethyl-2-phenyl imidazole, zinc(II) acetate, zinc(II) acetylacetonate, acetylacetone iron(III), acetylacetone cobalt(II) acetylacetone cobalt(III), aluminum isopropoxide, and titanium isopropoxide.

21. The method for manufacturing a functionally graded material according to claim 12, wherein
the catalyst for exhibiting a dynamic covalent bond accelerates a transesterification reaction.

22. The method for manufacturing a functionally graded material according to claim 12, wherein
the catalyst for exhibiting a dynamic covalent bond is any one of an organic catalyst such as N,N-dimethyl-4-aminopyridine, diazabicycloundecene, diazabicyclononene, triazabicyclodecene, 2-phenylimidazole, 2-phenyl-4-methylimidazole, 1-benzyl-2-phenyl imidazole, or 1-cyanoethyl-2-phenyl imidazole, zinc(II) acetate, zinc(II) acetylacetonate, acetylacetone iron(III), acetylacetone cobalt(II) acetylacetone cobalt(III), aluminum isopropoxide, and titanium isopropoxide, the resin composition is a thermosetting resin capable of exhibiting a dynamic covalent bond capable of reversible dissociation and addition by external stimulation.
